(19) United States
(12) Patent Application Publication
(10) Pub. No.: US 2010/0038864 A1
(43) Pub. Date: Feb. 18, 2010

(54) SEALING DEVICE

(75) Inventors: Yoshihiro Kuzumaki, Fukushima-shi (JP); Yuichi Shuto, Fukushima-shi (JP); Yoshimi Imamoto, Fujisawa-shi (JP)

Correspondence Address: HARNESS, DICKEY & PIERCE, P.L.C., P.O. BOX 828, BLOOMFIELD HILLS, MI, 48303, US

(73) Assignee: NOK Corporation, Tokyo (JP)

(21) Appl. No.: 12/440,402

(22) PCT Filed: Aug. 8, 2007
(86) PCT No.: PCT/JP2007/065482

§ 371 Date: Mar. 6, 2009

(30) Foreign Application Priority Data
Oct. 16, 2006 (JP) 2006-281241

(51) Int. Cl. F16J 15/32

(52) U.S. Cl. 277/560

(57) ABSTRACT

A sealing device with a side lip contacting with a surface angled relative to its axis in which the cross sectional shape of the side lip is optimized. Where the thickness of the tip end (5c) of the side lip (5) is T₁, the thickness of the base (5a) of the lip (5) is T₃, the length of the tip end (5c) is L₁, and the length of the base (5a) is L₂, T₁/T₃ is set to be not less than 0.7 and less than 0.8 and L₂/L₁ is set to be not less than 0.5 and less than 0.6.

### CROSS-REFERENCE TO RELATED APPLICATIONS

This is a national phase of International Application No. PCT/JP2007/065482 filed on Aug. 8, 2007 and published in Japanese language.

### BACKGROUND OF THE INVENTION

1. Field of the Invention

The present invention relates to a sealing device in accordance with a sealing technique. The sealing device in accordance with the present invention is used, for example, as a hub seal (a hub bearing seal) in an automotive associated field.

2. Description of the Conventional Art

Conventionally, a sealing device 51 shown in FIG. 4 has been known. The sealing device 51 is a sealing device which is attached to an outer race 61 of a bearing so as to slidably come into close contact with a rotating shaft 71, has an attaching ring 52 fixed to the outer race 61 and a rubber-like elastic body 53 attached to the attaching ring 52, and is integrally provided with seal lips (side lips, hereinafter referred to as “side lips”) 54 slidably coming into close contact with an end surface portion 71a of the rotating shaft 71, and a seal lip (a radial lip) 55 slidably coming into close contact with a peripheral surface portion 71b of the rotating shaft 71, on the rubber-like elastic body 53.

Since the sealing device 51 has the side lips 54 slidably coming into close contact with the end surface portion 71a of the rotating shaft 71, the sealing device 51 can achieve an excellent sealing effect with regard to dust resistance, particularly muddy water resistance, however, optimization of a sectional shape of the side lips 54 has not been sufficiently inquired.

Reference is made to Japanese Unexamined Patent Publication No. 2004-150484.

### SUMMARY OF THE INVENTION

### Problem to be Solved by the Invention

The present invention is made by taking the points mentioned above into consideration, and an object of the present invention is to optimize a sectional shape of a side lip, that is, a seal lip coming into contact with a surface having an angle with respect to a shaft, and more particularly to provide a sealing device with a seal lip achieving extremely excellent muddy water resistance.

### Means for Solving the Problem

In order to achieve the object mentioned above, in accordance with the present invention, there is provided a sealing device having a seal lip coming into contact with a surface having an angle with respect to a shaft, wherein a relation T₁/T₃ is set to be equal to or more than 0.7 and less than 0.8, and a relation L₂/L₁ is set to be equal to or more than 0.5 and less than 0.6 (0.7≦T₁/T₃<0.8, 0.5≦L₂/L₁<0.6), where a thickness of a lip tip in the seal lip is denoted by T₁, a thickness of a lip base is denoted by T₃, a length of the lip tip is denoted by L₁, and a length of the lip base is denoted by L₂.

### Effect of the Invention

In the structure of the present invention mentioned above, T₁/T₃ represents a lip thickness ratio between the lip tip and the lip base, and L₂/L₁ represents a lip length ratio between the lip tip and the lip base. If the lip tip is too thin or the lip base is too short, the lip bends too much and a surface pressure becomes short, thereby causing a leakage. On the contrary, if the lip tip is too thick or the lip base is too long, the lip does not bend sufficiently and the surface pressure becomes too large, thereby causing a leakage due to a sliding abrasion. A middle optimum range of T₁/T₃ is equal to or more than 0.7 and less than 0.8, and that of L₂/L₁ is equal to or more than 0.5 and less than 0.6, as mentioned above.

Therefore, in accordance with the present invention which optimizes the lip thickness ratio between the lip tip and the lip base, and the lip length ratio between the lip tip and the lip base, since a contact surface pressure of the seal lip is set suitably, it is possible to achieve an extremely excellent sealing performance or muddy water resistance.

### BRIEF EXPLANATION OF DRAWINGS

FIG. 1 is a sectional view of a substantial part of a sealing device in accordance with an embodiment of the present invention;

FIG. 2 is a sectional schematic view of a side lip in the sealing device;

FIG. 3(A) is a sectional schematic view of a sample 1 in a muddy water leakage test;

FIG. 3(B) is a sectional schematic view of a sample 2;

FIG. 3(C) is a sectional schematic view of a sample 3; and

FIG. 4 is a sectional view of a substantial part of a sealing device in accordance with a prior art.

### DETAILED DESCRIPTION OF PREFERRED EMBODIMENT

Next, a description will be given of an embodiment in accordance with the present invention with reference to the accompanying drawings.

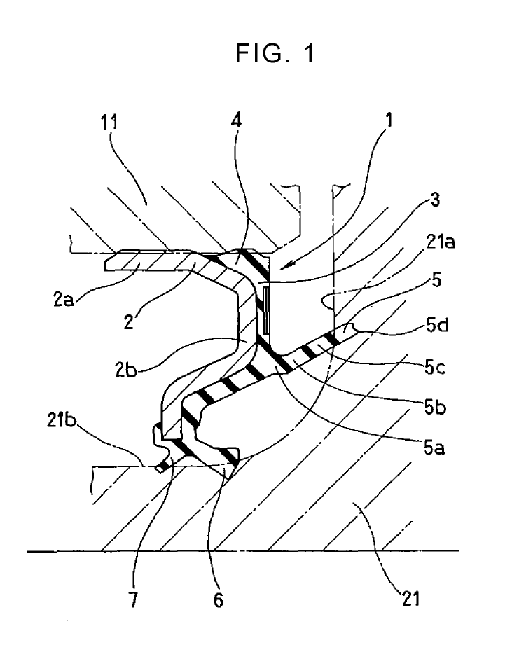

FIG. 1 shows a section of a substantial part of a sealing device 1 in accordance with an embodiment of the present invention. The sealing device 1 in accordance with the embodiment is used, for example, as a hub seal (a seal for a hub bearing) in a bearing portion in an automotive wheel suspension device, and is structured as follows.

First, there is provided a metal attaching ring (a metal ring) 2 fixed to an outer race 11 corresponding to an attaching member (a housing) in the bearing portion, and a rubber-like elastic body 3 is attached (vulcanization bonded) to the attaching ring 2. The attaching ring 2 is constructed by integrally forming of an inward flange portion 2b toward an inner side in a radial direction at one end in an axial direction of a tubular portion 2a which is fitted to an inner peripheral surface of the outer race 11. The rubber-like elastic body 3 is attached mainly to an end surface of a flange portion 2b in the attaching ring 2, and integrally has an outer peripheral seal portion 4 statically coming into close contact with the inner peripheral surface of the outer race 11, a seal lip (a side lip, hereinafter referred to as “side lip”) 5 slidably coming into close contact with an end surface portion (a surface) 21a of a rotating shaft (a shaft) 21, and a seal lip (a radial lip) 6 and a sub lip (a radial lip) 7 slidably coming into close contact with a peripheral surface portion (an outer peripheral surface) 21b of the rotating shaft 21, as constructing elements thereof. Only one side lip 5 is provided in the figure, however, a plurality of side lips may be provided. The rotating shaft 21 is structured in the figure such that the end surface portion 21a and the peripheral surface portion 21b are integrally formed, however, may be structured such that a metal ring (a slinger, not shown) having an end surface portion is separately fitted to the normal rotating shaft 21 having the peripheral surface portion 21b. Further, the end surface portion 21a is not necessarily formed as a plane perpendicular to an axis, but may be formed as a surface having an angle with respect to the axis (a center axis).

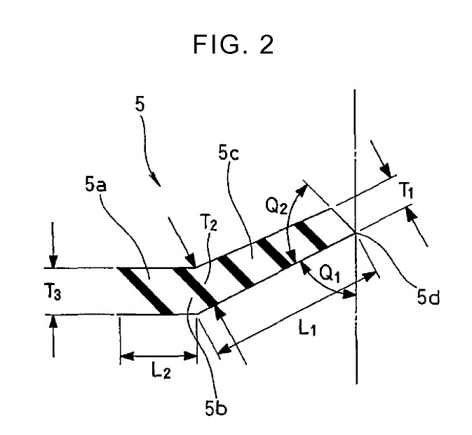

As mentioned above, the present invention aims at optimizing the sectional shape of the side lip 5, and the side lip 5 in the embodiment is constructed by integrally forming of a lip tip 5c at a tip side (a right end side in the figure) of a lip base 5a of the side lip via a bent portion (a deflection portion) 5b, as shown in a schematic view in FIG. 2 enlargedly. The lip base 5a is formed in an approximately cylindrical surface shape, and has predetermined thickness T₃ and length L₂. The lip tip 5c is formed in a circular conical surface shape in such a manner that a diameter is enlarged little by little from its proximal end portion (a left end portion in the figure) at the lip base 5a side toward its distal end portion (a right end portion in the figure), and a predetermined angle of gradient Q₁ is set with respect to the plane perpendicular to the axis. Further, the lip tip 5c is formed in such a manner that its thickness is reduced little by little from its proximal end portion toward its distal end portion. In other word, when a thickness at the proximal end portion is denoted by T₂, a thickness at the distal end portion is denoted by T₁, the lip tip 5c is set so as to satisfy a relation T₂>T₁. In the invention of the present application, “thickness T₁ of the lip tip” means the smaller thickness T₁ at the distal end portion. Further, in the case of being formed such that the thickness of the lip base 5a is reduced little by little from the proximal end portion toward the distal end portion, “thickness T₃ of the lip base” described in the invention of the present application means the larger thickness T₃ at the proximal end portion. Further, the lip tip 5c has a lip end edge 5d having a predetermined peak angle Q₂ in its edge, and a surface extending from the lip end edge 5d toward an inner peripheral surface of the lip tip 5c comes into contact with the end surface portion 21a of the rotating shaft 21.

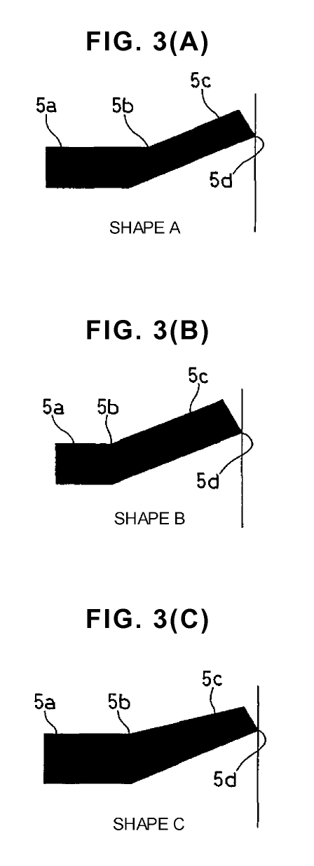

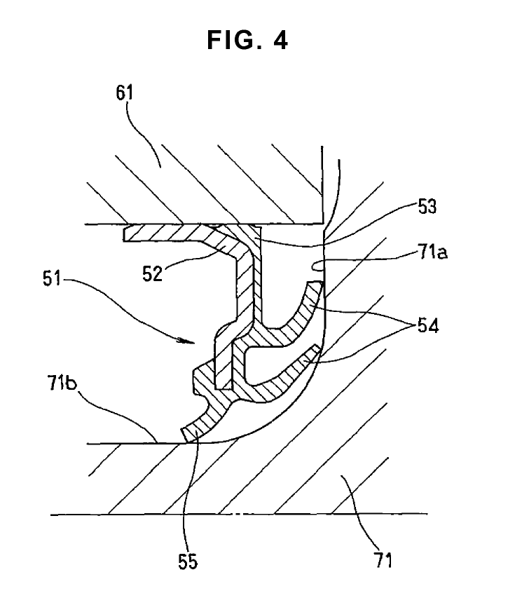

As mentioned above, the lip thickness ratio T₁/T₃ between the lip tip 5c and lip base 5a and the lip length ratio L₂/L₁ between the lip base 5a and the lip tip 5c extremely greatly affect the sealing performance. If the lip tip 5c is too thin or the lip base 5a is too short, the lip 5 bends too much and a contact surface pressure becomes short, thereby causing a leakage. On the contrary, if the tip lip 5c is too thick or the lip base 5a is too long, the lip 5 can not sufficiently bend and the contact surface pressure becomes too large, whereby a sliding abrasion is promoted and a leakage is caused. In this regard, in accordance with an information known from a result of a muddy water leakage test carried out by the inventors of the present invention, if T₁/T₃ is set within a range of being equal to or more than 0.7 and less than 0.8, and L₂/L₁ is set within a range of being equal to or more than 0.5 and less than 0.6, the muddy water leakage does not occur, and a good result can be obtained. One example of the muddy water leakage test is shown below.

[Sample 1] shape A . . . T₁/T₃ is set to 0.727 and L₂/L₁ is set to 0.583 in which the thickness T₁ of the lip tip in the side lip 5 is set to 0.4 mm, the thickness T₃ of the lip base is set to 0.55 mm, the length L₁ of the lip tip 5c is set to 1.8 mm, and the length L₂ of the lip base 5a is set to 1.05 mm (refer to FIG. 3(A))

[Sample 2] shape B . . . T₁/T₃ is set to 0.909 and L₂/L₁ is set to 0.378 in which the thickness T₁ of the lip tip in the side lip 5 is set to 0.5 mm, the thickness T₃ of the lip base is set to 0.55 mm, the length L₁ of the lip tip 5c is set to 1.85 mm, and the length L₂ of the lip base 5a is set to 0.7 mm (refer to FIG. 3(B))

[Sample 3] shape C . . . T₁/T₃ is set to 0.554 and L₂/L₁ is set to 0.611 in which the thickness T₁ of the lip tip in the side lip 5 is set to 0.36 mm, the thickness T₃ of the lip base is set to 0.65 mm, the length L₁ of the lip tip 5c is set to 1.8 mm, and the length L₂ of the lip base 5a is set to 1.1 mm (refer to FIG. 3(C))

[Test condition and result] As a result of seal operation of the samples 1 to 3 under an actual device working condition, the muddy water leakage does neither occur in the sample 1 after fifty hour has passed nor after one hundred hour has passed, as shown in the following Table 1. On the contrary, the muddy water leakage occurs in the samples 2 and 3 both after fifty hour has passed and after one hundred hour has passed.

TABLE 1

| | dimension (mm) | | | | | | muddy water test result | | |
|---|---|---|---|---|---|---|---|---|---|
| | T₁ | T₃ | L₁ | L₂ | T₁/T₃ | L₂/L₁ | 50 hours | 100 hours | determination |
| sample 1 | 0.4 | 0.55 | 1.8 | 1.05 | 0.727 | 0.583 | ◯ | ◯ | ◯ |
| (shape A) | | | | | | | | | |
| sample 2 | 0.5 | 0.55 | 1.85 | 0.7 | 0.909 | 0.378 | X | X | X |
| (shape B) | | | | | | | | | |
| sample 3 | 0.36 | 0.65 | 1.8 | 1.1 | 0.554 | 0.611 | X | X | X |
| (shape C) | | | | | | | | | |

The sample 1 having the good result is structured such that the lip thickness ratio T₁/T₃ and the lip length ratio L₂/L₁ are respectively in the ranges of 0.7 ≦ T₁/T₃ < 0.8 and 0.5 ≦ L₂/L₁ < 0.6 as in the present invention.

What is claimed is:

1. A sealing device having a seal lip coming into contact with a surface having an angle with respect to a shaft, wherein a relation T₁/T₃ is set to be equal to or more than 0.7 and less than 0.8, and a relation L₂/L₁ is set to be equal to or more than 0.5 and less than 0.6, where a thickness of a lip tip in said seal lip is denoted by T₁, a thickness of a lip base is denoted by T₃, a length of the lip tip is denoted by L₁, and a length of the lip base is denoted by L₂.
